(19) United States
(12) Patent Application Publication
(10) Pub. No.: US 2008/0126070 A1
(43) Pub. Date: May 29, 2008

(54) Detecting Inconsistencies Among System Models

(76) Inventors: Shady Copty, Nazareth (IL); Felix Geller, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/464,213

(22) Filed: Aug. 14, 2006

(51) Int. Cl. G06F 9/45

(52) U.S. Cl. 703/22

(57) ABSTRACT

Systems and methods for determining whether a first system model is consistent with a second system model in a verification system are provide. The method comprises generating a first constraint satisfaction problem (CSP) from a first system model; solving the first CSP to generate a first solution; generating a second CSP from a second system model; determining that the first and second system models are inconsistent, in response to the first solution failing to validate against the second CSP; solving the second CSP to generate a second solution; and determining that the first and second system models are inconsistent, in response to the second solution failing to validate against the first CSP.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to verification systems and, more particularly, to determining inconsistencies between system models used for a test generator.

### BACKGROUND

Functional verification is a process that ensures conformance of a hardware or software design to its specification. The verification process includes defining a system model and a test plan for a set of events that the verification team would like to observe during the verification process. The system model is fed to a test generator that produces test cases for verification purposes.

Test cases are designed to trigger architecture and micro-architecture events defined by the verification plan. Test case generation technology can be based on constraint modeling of the generation task, coupled with stimuli generation schemes driven by solving constraint satisfaction problems (CSPs).

Referring to FIG. 1, a test generator 100 can be implemented in terms of a CSP 140 fed to a CSP solver 150. The constraints may be defined by a system model 110 and a test template 120, and solved based on a random seed 130 is used to guide non-deterministic choices of CSP solver 150 and to direct CSP solver to a different solution while other inputs are fixed. A CSP solution 160 generated by the CSP solver 150 can be translated into a test case 170 used for verification.

A system model's 100 design may be as complex as the hardware or software architecture it represents. The complexity of some system models can be reduced by way of “refactoring,” a process utilized to modify logic code without changing the results or internal behavior of the code. As such, refactoring is performed to improve the understandability of the system model or to change its structure and design for better human maintenance.

For example, refactoring can be used for removing unused portions of the code, changing a variable name into something more meaningful, turning blocks of related code into a subroutine, etc. (See “Refactoring: Improving the Design of Existing Code”, Martin Fowler et al, Addison-Wesley Professional, June 1999, incorporated by reference herein in entirety).

As another example, a modeler may be required to build a model for the following behavior:

Variables: A.Address, A.Length, B.Address, B.Length, C.Address, C.Length, modeProperty required behavior. The objective is to place A, B and C one after the other in memory. The modeler knows that Length of A, B and C are 5, so he places a constraint:
“A.Length=5 and B.Length=5 and C.Length=5 and B.Address=A.Address+5 and C.Address=B.Address+5”

The modeler may be told that the size of B is dependant on “modeProperty” such that if mode is 1 then size is 5, and if mode is 2 then size is 10. So the modeler fixes his constraint as provided below:
A.Length=5 and
B.Length=5 *modeproperty and C.Length=5 and
B.Address=A.Address+5 * modeProperty and
C.Address=B.Address+5

A third mode may be introduced in which b's length is 11 and c's length is 12, where:
A.Length=5; and
B.Length=5 *modeproperty; and
C.Length=5; and
(modeproperty=1 or modeProperty=2)→B.Address=A.Address+5 * modeProperty; and
(modeproperty=3)→B.Address=A.Address+11; and
(modeproperty=1 or modeProperty=2)→C.Address=B.Address+5; and
(modeproperty=3)→C.Address=B.Address+12.

A refactoring of this constraint network (which maintains the behavior) would look like the following:

A.length=5 and (modeproperty=1)→(B.Length=5) and (modeproperty=2)→(B.Length=10) and (modeproperty=3)→(B.Length=11) and (modeproperty=1 or modeProperty=2)→(C.Length=5) and (modeproperty=3)→(C.Length=12) and B.Address=A.Address+A.Length and C.Address=B.Address+b.length.

Once the system model for a test generator is refactored, there is a need to verify that the test generator is behaving as it did before refactoring. That is, the resulting test generator should not generate new test cases that were illegal under the original test generator. Also, the new test generator should have a reasonable probability of generating all the test cases that the original test generator produced.

Unfortunately, the current methods and systems for detecting the above-noted changes in behavior are hard to implement and are rather arcane. For example, the current solutions include either manually comparing the system models or manually inspecting the generated test cases for inconsistencies. Intricate hardware or software checker systems may be also implemented to analyze the generated solutions.

The above schemes require special expertise, and are expensive and time consuming to implement. Further, while conventional methods can be used to generally validate whether the test cases generated by the refactored model are valid, one cannot determine whether or not the generated test cases cover the same solution space as before the refactoring process.

Systems and methods are needed to address the above-mentioned shortcomings.

### SUMMARY

The present disclosure is directed to a system and corresponding methods that facilitate determining inconsistencies among system models used in a test generator in a verification system.

Certain aspects, advantages and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, systems and methods for determining whether a first system model is consistent with a second system model are provided. The method comprises generating a first constraint satisfaction problem (CSP) from a first system model; solving the first CSP to generate a first solution; generating a second CSP from a second system model; and determining that the first and second system models are inconsistent, in response to the first solution failing to validate against the second CSP.

The method may further comprise solving the second CSP to generate a second solution; and determining that the first and second system models are inconsistent, in response to the second solution failing to validate against the first CSP. In one embodiment, the first system model is refactored to generate the second system model.

The first solution failing to validate against the second CSP may indicate that there is at least one test case for the first system model that cannot be generated by a second test generator based on the second system model. The second solution failing to validate against the first CSP may indicate that there is at least one test case for the second system model that is not feasible for a first test generator based on the first system model.

In one embodiment, input to the second test generator comprises the second system model and a test template; input to the first test generator comprises the first system model and the test template. In some embodiments, input to the first and second test generators further comprises first and second random seeds, respectively.

In accordance with another embodiment, a computer program product comprising a computer useable medium having a computer readable program is provided. The computer readable program when executed on a computer causes the computer to perform the processes associated with the methods discussed above.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates a block diagram of a test generator, implemented based on a constraint satisfaction problem (CSP), in accordance with embodiment.

FIG. 2 is a block diagram of a system for comparing the solution space generated by two test generators, in accordance with one embodiment.

FIG. 3 is a flow diagram of a method for detecting inconsistencies between the solution space of first and second test generators, in accordance with a one embodiment.

FIGS. 4A and 4B are block diagrams of hardware and software environments in which a system of the present invention may operate, in accordance with one or more embodiments.

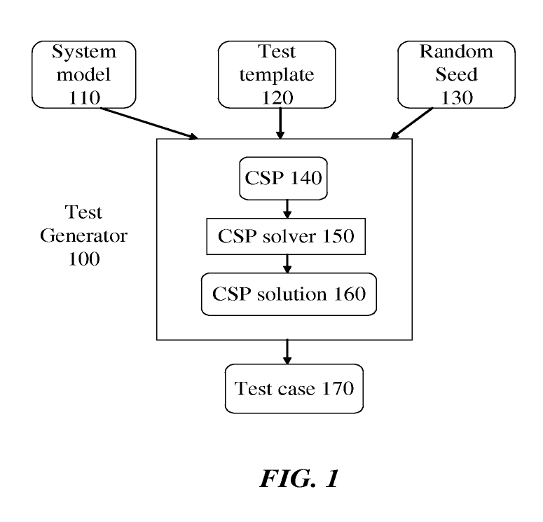

Features, elements, and aspects of the invention that are referenced by the same numerals in different figures represent the same, equivalent, or similar features, elements, or aspects, in accordance with one or more embodiments.

### DETAILED DESCRIPTION OF PREFERRED EMBODIMENTS

The present disclosure is directed to systems and corresponding methods that facilitate determining inconsistencies between a first system model and a second system model. In the following, one embodiment is disclosed by way of example as applicable to determining inconsistencies between a system model and its refactored version. It is noteworthy, however, that other embodiments may be utilized to determine inconsistencies between any two system models.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

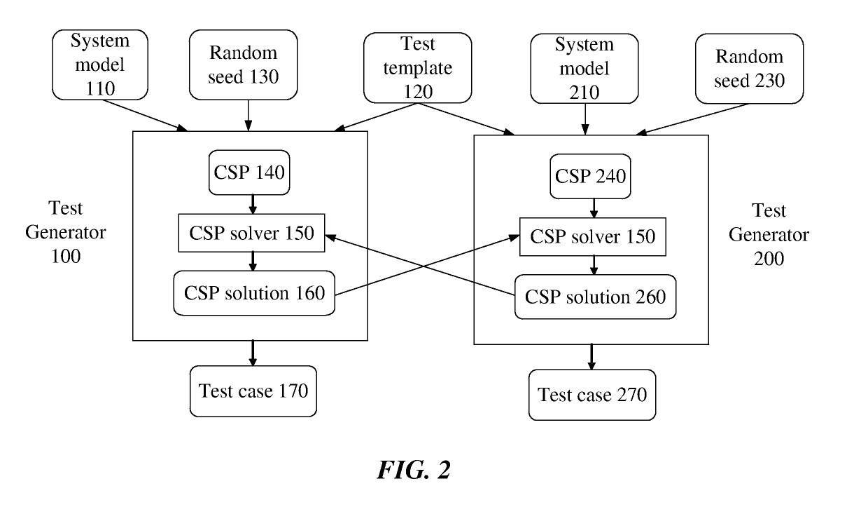

Referring to FIG. 2, system models 110 and 210 and the respective test generators 100 and 200, in accordance with one aspect of the invention are illustrated. Each test generator 100 or 200 is built around a CSP solver 150, and is used to find solutions for respective CSPs 140 and 240. System models 110 and 210 respectively define CSPs 140 and 240.

In one embodiment, system models 110 and 210 are expressed in terms of sets of variables and a network of constraints applicable to those variables. Certain test requirements such as additional constraints, domain limitations or probabilistic requests may be inputted to each test generator 100 or 200 in various forms, for example, by way of a test template 120.

CSP solver 150 finds one or more solutions to a CSP (e.g., CSP 140 or 240) by assigning different values to each variable within the context of the defined constraints. In other words, each solution found by CSP solver 150 is a random concrete solution, given values of the variables that satisfy the defined constraints, in compliance with test template 120, for example.

In one embodiment, test generators 100 and 200 comprise a general-purpose or a dedicated computer programmed with suitable software to carry out the operations described in more detail below. The software may be executed over a hardware environment and implemented as test generators 100 or 200. The respective software may be provided and installed in electronic form, over a network communication link, or as embedded in tangible media, such as CD-ROM or DVD.

Certain aspects of CSP solver systems are described in U.S. patent application Ser. No. 09/788,152, filed Feb. 16, 2001 (published as US 2002/0169587 A1), the content of which is incorporated herein by reference in entirety. A person skilled in the related art would appreciate that although the exemplary embodiments provided here are disclosed as applicable to a CSP solver for verification of a system's design, the principles of the present invention may be applied in solving a wide range of constraint satisfaction problems.

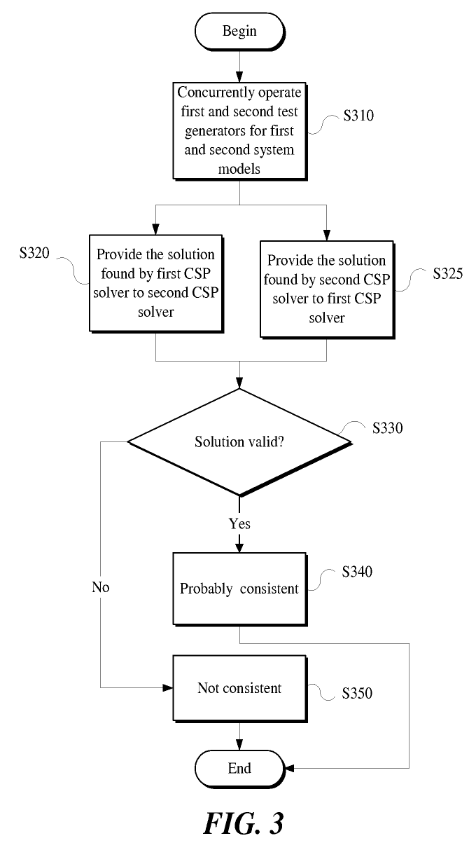

Referring to FIGS. 2 and 3, in an exemplary embodiment, system model 210 is a refactored version of system model 110, without detracting from the scope of the invention. To determine whether the two system models are consistent, test generators 100 and 200 are, preferably, concurrently operated (S310). Test generator 100 is executed according to input provided by system model 110, random seed 130 and test template 120, for example. And, test generator 200 is executed according to input provided by system model 210, random seed 230 and test template 120.

In certain embodiments, the two test generators 100 and 200 do not operate concurrently. Regardless of the order of operation, CSP solution 160 is generated by test generator 100 and CSP solution 260 is generated by test generator 200. CSP solutions 160 and 260 may be translated to test case 170 and test case 270, respectively. Where system model 210 is a modified (e.g., refactored) version of the system model 110, it is desirable to determine whether test case 270 is feasible within the context of system model 110, and whether test case 170 is probable within the context of system model 210.

In one embodiment, CSP solution 160 is provided to CSP solver 150 of test generator 200 for validation (S320). If solution 160 is validated (i.e., it is a valid solution within the context of constraints defined by CSP 240), then it is determined that system model 210 can be used to generate the same test case as that generated by system model 110 (i.e., test generator 200 has some probability of generating the same test cases as test generator 100).

In certain embodiments, CSP solution 260 is provided to CSP solver 150 of test generator 100 for validation (S325). If solution 260 is validated (i.e., it is a valid solution within the context of constraints defined by CSP 140), then it is determined that system model 210 can be used to generate test cases that are feasible within the context of system model 100 (i.e., test generator 200 does not generate test cases that test generator 100 cannot generate).

Random seeds 130 and 230 are preferably used to affect the randomness and in certain cases get the same sequence of random numbers. In one embodiment, random seeds 130 and 230 are used to guide non-deterministic choices of CSP solver 150 and to direct CSP solver 150 to a different solution while other inputs are fixed.

A parameter N, for example, is used to dictate a confidence level, by forcing a predefined number of iterations for each of the above two operations defined in S320 and S325. Accordingly, a higher value assigned to the parameter N will result in verification of a larger number of CSP solutions. If the result from said verifications indicates that the generated CSP solutions are valid (S330), then it is determined that system models 110 and 210 are probably consistent (S340). Otherwise, it is determined that system models 110 and 210 are not consistent (S350).

As noted, to obtain a high level of confidence both of the above operations in S320 and S325 may be performed, preferably, concurrently or in alternate order, and several times according to the value of parameter N. If a high level of confidence is obtained, then it is an indication that system model 210 is consistent with system model 110 and can therefore be used instead of system model 110 for the purpose of creating test cases for verification of a system modeled after system model 110.

Depending on implementation, the invention can be implemented either entirely in the form of hardware or entirely in the form of software, or a combination of both hardware and software elements. For example, test generators 100 and 200 may comprise a controlled computing system environment that can be presented largely in terms of hardware components and software code executed to perform processes that achieve the results contemplated by the system of the present invention.

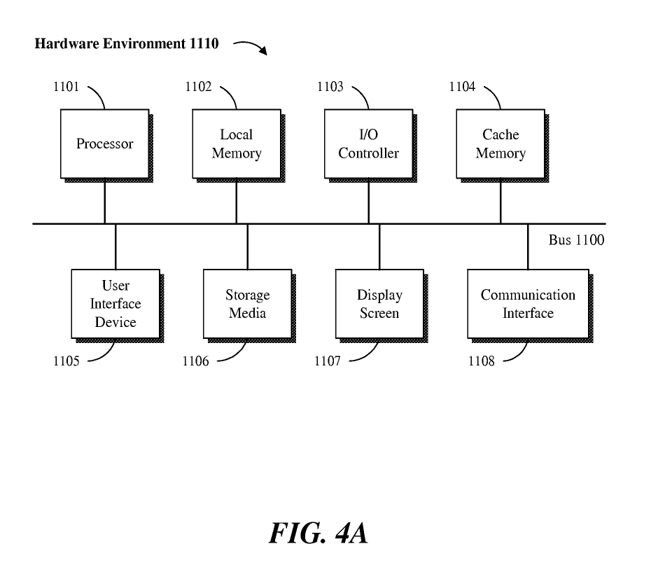

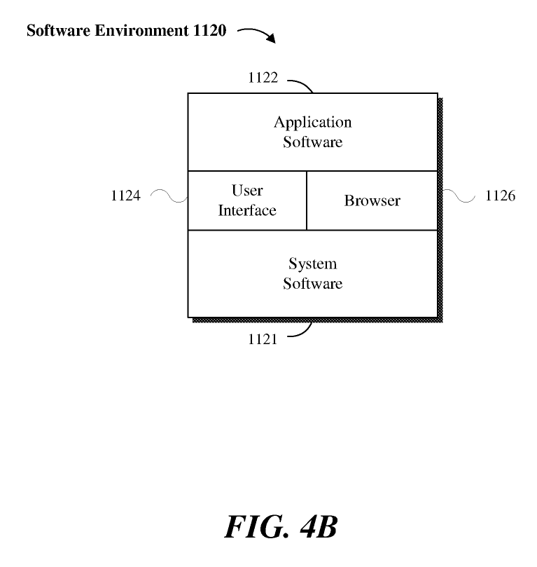

Referring to FIGS. 4A and 4B, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. System software 1121 comprises control programs, such as the operating system (OS) and information management systems that instruct the hardware how to function and process information.

In a preferred embodiment, CSP solver 150 is implemented as application software 1122 executed on one or more hardware environments to solve a CSP, as provided earlier. Application software 1122 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

Referring to FIG. 4A, an embodiment of the application software 1122 can be implemented as computer software in the form of computer readable code executed on a data processing system such as hardware environment 1110 that comprises a processor 1101 coupled to one or more memory elements by way of a system bus 1100. The memory elements, for example, can comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 4B, application software 1122 can comprise one or more computer programs that are executed on top of system software 1121 after being loaded from storage media 1106 into local memory 1102. In a client-server architecture, application software 1122 may comprise client software and server software. For example, in one embodiment of the invention, client software is executed on a computing terminal and server software is executed on test generator 200.

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention and are further defined by the claims and their full scope of equivalents.

What is claimed is:

1. A method for determining whether a first system model is consistent with a second system model in a verification system, the method comprising:
generating a first constraint satisfaction problem (CSP) from a first system model;
solving the first CSP to generate a first solution;
generating a second CSP from a second system model; and
determining that the first and second system models are inconsistent, in response to the first solution failing to validate against the second CSP.

2. The method of claim 1, further comprising:
solving the second CSP to generate a second solution; and
determining that the first and second system models are inconsistent, in response to the second solution failing to validate against the first CSP.

3. The method of claim 1, further comprising refactoring the first system model to generate the second system model.

4. The method of claim 1, wherein the first solution failing to validate against the second CSP indicates that there is at least one test case for the first system model that cannot be generated by a second test generator based on the second system model.

5. The method of claim 2, wherein the second solution failing to validate against the first CSP indicates that there is at least one test case for the second system model that is not feasible for a first test generator based on the first system model.

6. The method of claim 4, wherein input to the second test generator comprises the second system model and a test template.

7. The method of claim 5, wherein input to the first test generator comprises the first system model and a test template.

8. The method of claim 4, wherein input to the second test generator comprises the second system model and a second random seed.

9. The method of claim 5, wherein input to the first test generator comprises the first system model and a first random seed.

10. A system for determining whether a first system model is consistent with a second system model in a verification system, the system comprising:
a logic unit for generating a first constraint satisfaction problem (CSP) from a first system model;
a logic unit for solving the first CSP to generate a first solution;
a logic unit for generating a second CSP from a second system model; and
a logic unit for determining that the first and second system models are inconsistent, in response to the first solution failing to validate against the second CSP.

11. The system of claim 10, further comprising:
a logic unit solving the second CSP to generate a second solution; and
a logic unit determining that the first and second system models are inconsistent, in response to the second solution failing to validate against the first CSP.

12. The system of claim 10, further comprising a logic unit for refactoring the first system model to generate the second system model.

13. The system of claim 10, wherein the first solution failing to validate against the second CSP indicates that there is at least one test case for the first system model that cannot be generated by a second test generator based on the second system model.

14. The system of claim 12, wherein the second solution failing to validate against the first CSP indicates that there is at least one test case for the second system model that is not feasible for a first test generator based on the first system model.

15. A computer program product comprising a computer useable medium having a computer readable program, wherein the computer readable program when executed on a computer causes the computer to:
generate a first constraint satisfaction problem (CSP) from a first system model;
solve the first CSP to generate a first solution;
generate a second CSP from a second system model; and
determine that the first and second system models are inconsistent, in response to the first solution failing to validate against the second CSP.

16. The computer program product of claim 15, wherein the computer readable program when executed on a computer further causes the computer to:
solve the second CSP to generate a second solution; and
determine that the first and second system models are inconsistent, in response to the second solution failing to validate against the first CSP.

17. The computer program product of claim 15, wherein the computer readable program when executed on a computer further causes the computer to refactor the first system model to generate the second system model.

18. The computer program product of claim 15, wherein the first solution failing to validate against the second CSP indicates that there is at least one test case for the first system model that cannot be generated by a second test generator based on the second system model.

19. The computer program product of claim 16, wherein the second solution failing to validate against the first CSP indicates that there is at least one test case for the second system model that is not feasible for a first test generator based on the first system model.

20. The computer program product of claim 18, wherein input to the second test generator comprises the second system model and a test template.
